(19) United States
(12) Patent Application Publication
(10) Pub. No.: US 2022/0368549 A1
(43) Pub. Date: Nov. 17, 2022

(54) METHOD OF CONDUCTING A MEETING AND CONTROLLING A MEETING TERMINAL WITH A CLIENT DEVICE

(71) Applicant: Charles Lap San CHAN, Taipei (TW)

(72) Inventor: Charles Lap San CHAN, Taipei (TW)

(21) Appl. No.: 17/728,613

(22) Filed: Apr. 25, 2022

(30) Foreign Application Priority Data
May 12, 2021 (TW) 110117107

(51) Int. Cl. H04L 12/18; H04L 65/613; H04L 65/1089

(52) U.S. Cl. CPC H04L 12/1822; H04L 12/1818; H04L 65/613; H04L 65/1089

(57) ABSTRACT

In a method of conducting a meeting and controlling a meeting terminal with a client device, users conveniently uses their own account on different terminal devices to share data. The method prevents users from forgetting to log out of their accounts on other devices and allows users to operate with familiar devices and user interface for control. Besides, the method can also flexibly allow the user to select the functional unit of the client device or the meeting terminal for application according to the situation during the video meeting.

This application claims priority of Application No. 110117107 filed in Taiwan on 12 May 2021 under 35 U.S.C. § 119; the entire contents of all of which are hereby incorporated by reference.

### BACKGROUND OF THE INVENTION

### Field of the Invention

The present invention relates to a method of conducting a meeting and controlling a meeting terminal with a client device, particularly to a method for conducting a meeting that can distribute meeting data to at least two devices.

### Description of the Related Art

In common commercial applications, conducting an online video meeting with participants at long distances is a beneficial way to save transportation expenses, save time for convening a meeting of participants, and enable real-time communication. In order to achieve the purpose of conducting online video meetings, companies often have to set up an online meeting system in most of meeting rooms, and then the host of the meeting logs into the online meeting system with his/her own account. However, in this method, users often forget to log out of their user accounts, which lacks security. Furthermore, some online meeting systems can only conduct online meetings with the dedicated account of the system (e.g., “name of device in meeting room A” as the account). As a result, users cannot use their own accounts on such systems and obtain a list of contacts, meeting schedules, etc. of their own accounts.

In addition, because enterprises may purchase online conference systems of different brands at different times, or purchase online conference systems of the same brand and different versions, users need to learn to employ different operating interfaces or different input tools (e.g., remote control, keyboard, mouse, or tablet computer, etc.), causing difficulty for users to operate.

In view of the above description, the user has concerns about the security of operating the online meeting system and the problem that cannot use his/her own account, and may have to face the trouble of the operation interface of the online conference system of different brands and versions, or face the inconvenience of using different input tools. Therefore, how to improve and provide quick and convenient solutions has become a research direction for those skilled in the art.

### SUMMARY OF THE INVENTION

The primary objective of the present invention is to provide a method of conducting a meeting and controlling a meeting terminal with a client device, which prevents users from forgetting to log out of their accounts on other devices.

Another objective of the present invention is to provide a method of conducting a meeting and controlling a meeting terminal with a client device, which conveniently uses your own account on different terminal devices to share data.

Further objective of the present invention is to provide a method of conducting a meeting and controlling a meeting terminal with a client device, which allows users to operate with familiar devices and user interface for control.

To achieve the abovementioned objectives, the present invention provides a method of conducting a meeting and controlling a meeting terminal with a client device. The client device, the meeting terminal, and a meeting server are connected to each other via a network. The method operates in an environment of the meeting server, the client device, and the meeting terminal and includes:
(A) pairing the client device with the meeting terminal;
(B) configuring the client device into a control mode corresponding to the paired client device and the paired meeting terminal;
(C) configuring the meeting terminal into a display mode corresponding to the paired client device and the paired meeting terminal;
(D) operating the client device to enable the meeting terminal to conduct a video meeting corresponding to the client device configured in a control mode; and
(E) by the meeting server, transmitting meeting video data to the meeting terminal corresponding to the client device configured in a control mode.

The features, advantages, or similar expressions mentioned in the specification do not mean that all the features and advantages that can be realized by the present invention should be in any single specific embodiment of the present invention. Rather, it should be understood that the expression of related features and advantages means that the specific features, advantages, or characteristics described in conjunction with specific embodiments are included in at least one specific embodiment of the present invention. Therefore, the discussion of features and advantages, and similar expressions in the specification is related to the same specific embodiment, but it is not necessary.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a system of conducting a meeting and controlling a meeting terminal with a client device according to a preferred embodiment of the present invention; and

FIG. 2 is a flowchart of a method of conducting a meeting and controlling a meeting terminal with a client device according to a preferred embodiment of the present invention.

### DETAILED DESCRIPTION OF THE INVENTION

In order to make the description of the present disclosure more detailed and complete, the following provides an illustrative description for the implementation aspects and specific embodiments of the present invention; but this is not the only way to implement or use specific embodiments of the present invention. The implementation manners cover the characteristics of a number of specific embodiments and the steps and sequences of the method used to construct and operate these specific embodiments. However, other specific embodiments can also be used to achieve the same or equal functions and sequence of steps.

The present invention provides a method of conducting a meeting and controlling a meeting terminal with a client device, which prevents users from forgetting to log out of their accounts on other devices, conveniently uses your own account on different terminal devices to share data, and allows users to operate with familiar devices and user interface for control. In addition, the method of the present invention can also flexibly allow the user to select the functional unit of the client device or the meeting terminal for application according to the situation during the video meeting.

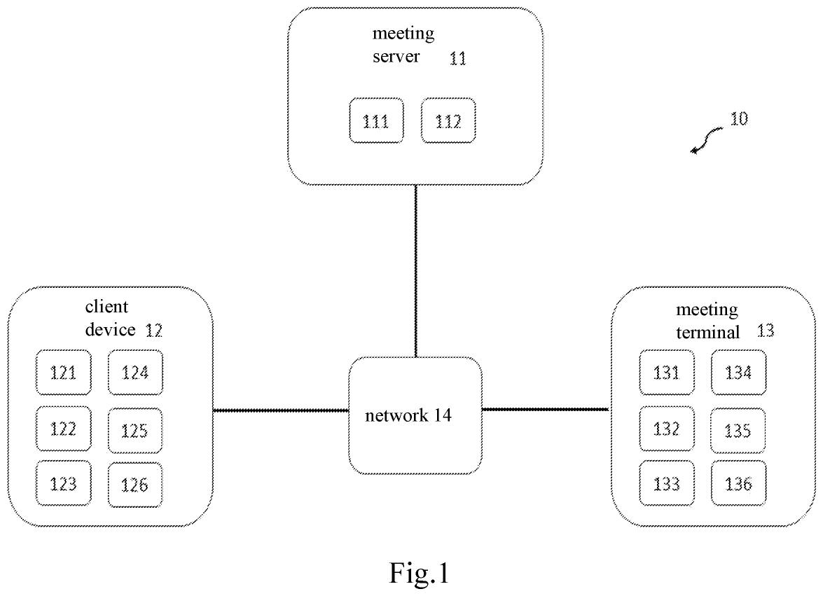

Please refer to FIG. 1. FIG. 1 is a schematic diagram illustrating a system of conducting a meeting and controlling a meeting terminal with a client device according to a preferred embodiment of the present invention. The purposes of each device in the system and functional units therein are described as follows. Then, the operation flow of the system is further described. As illustrated in FIG. 1, the system includes a meeting server 11, a client device 12, and a meeting terminal 13. The meeting server 11, the client device 12, and the meeting terminal 13 are connected to each other via a network 14. The meeting server 11 includes a processing unit 111 and a storage unit 112. The client device 12 includes a processing unit 121, a microphone 122, a camera 123, a display unit 124, an input unit 125, and a speaker 126. The meeting terminal 13 includes a processing unit 131, a microphone 132, a camera 133, a display unit 134, an input unit 135, and a speaker 136.

The processing unit 111 of the meeting server 11 may be used to indicate that the client device 12 and the meeting terminal 13 have been paired, that the client device 12 is configured into a control mode, that the meeting terminal 13 is configured into a display mode, that meeting data are transmitted, that meeting video data are transmitted, and that meeting audio data are transmitted, but the present invention is not limited thereto. The storage unit 112 stores the respective hardware identifications (IDs) of the meeting server 11 and the client device 12, the meeting membership of the client device 12 (e.g., account and password), and the meeting data corresponding to the meeting membership (e.g., including a list of meeting members and a meeting schedule, etc.).

The processing unit 121 of the client device 12 may be used to perform a meeting control operation, transmit user video data and user audio data, and conduct a video meeting. The microphone 122 is used to obtain the user audio data. The camera 123 is used to obtain the user video data. The display unit 124 is used to display the meeting data and the meeting video data. The input unit 125 is used to provide a user interface. The user inputs the meeting control operation through the user interface. The speaker 126 is used to play the meeting audio data. It should be understood that the present invention is not limited to the operation of the client device 12.

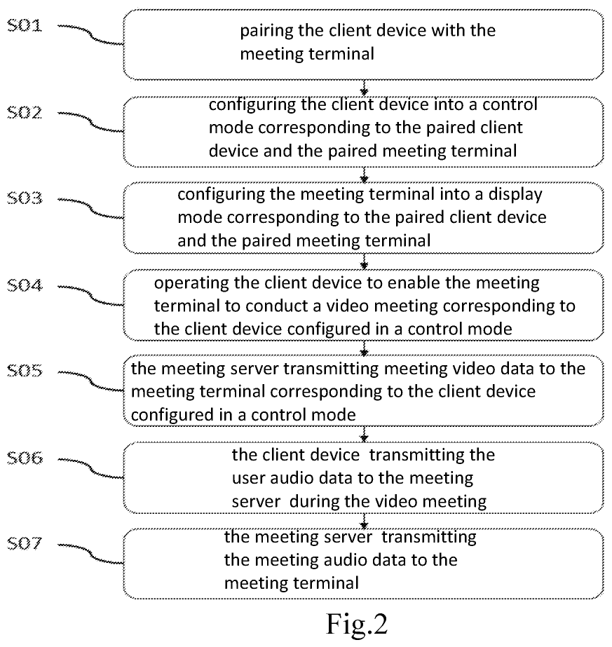

FIG. 2 is a flowchart of a method of conducting a meeting and controlling a meeting terminal with a client device according to a preferred embodiment of the present invention. Please refer to FIG. 1 and FIG. 2. Firstly, in Step S01, the client device 12 is paired with the meeting terminal 13. For example, the display unit 134 of the meeting terminal 13 may display a QR CODE. The user operates the camera 123 of the client device 12 to scan the QR CODE. Alternatively, the display unit 134 of the meeting terminal 13 may display a paired account and a password. The user operates the input unit 125 of the client device 12 to log into the paired account and password on a specific webpage. It should be understood that the present invention is not limited to the pairing manner.

In Step S02, the client device 12 is configured into a control mode corresponding to the paired client device 12 and the paired meeting terminal 13. In an embodiment of the present invention, the storage unit 112 of the meeting server 11 stores the respective hardware IDs of the client device 12 and the meeting terminal 13. As a result, after the client device 12 is paired with the meeting terminal 13, the processing unit 111 of the meeting server 11 can indicate that the client device 12 has been paired with the meeting terminal 13, configure the client device 12 into a control mode, and store the information into the storage unit 112.

In Step S03, the meeting terminal 13 is configured into a display mode corresponding to the paired client device 12 and the paired meeting terminal 13. As mentioned in Step S02, the storage unit 112 of the meeting server 11 stores the respective hardware IDs of the client device 12 and the meeting terminal 13. As a result, after the client device 12 is paired with the meeting terminal 13, the processing unit 111 of the meeting server 11 can indicate that the client device 12 has been paired with the meeting terminal 13, configure the meeting terminal 13 into a display mode, and store the information into the storage unit 112.

In Step S04, the client device 12 is operated to enable the meeting terminal 13 to conduct a video meeting corresponding to the client device 12 configured in a control mode. In this step, the user employs the input unit 125 of the client device 12 to transmit a command for conducting the video meeting to the meeting server 11, and then the meeting server 11 transfers the command to the meeting terminal 13. The processing unit 131 of the meeting terminal 13 and the meeting server 11 create a link of the video meeting and conduct the video meeting based on the command Simultaneously, the processing unit 121 of the client device 12 and the meeting server 11 also create the link of the video meeting and conduct the video meeting. Besides, in an embodiment of the present invention, the camera 133 of the meeting terminal 13 obtains the user video data during the video meeting. In another embodiment, the camera 123 of the client device 12 may obtain the user video data during the video meeting.

In Step S04, when the client device 12 and the meeting server 11 create the link of the video meeting, the meeting server 11 transmits the meeting data to the client device 12 and the display unit 124 of the client device 12 displays the meeting data. The user can employ the input unit 125 to operate the client device 12, which enables the meeting terminal 13 to conduct the video meeting. In another embodiment of the present invention, the meeting server 11 transmits the meeting data to the meeting terminal 13 and the display unit 134 of the meeting terminal 13 displays the meeting data in Step S04 when the meeting terminal 13 and the meeting server 11 create the link of the video meeting. The user can employ the input unit 125 to operate the client device 12, which enables the meeting terminal 13 to conduct the video meeting. As can be seen from the foregoing description, regardless of whether the meeting data are displayed on the client device 12 or the meeting terminal 13, the user can operate his/her own client device 12 to conduct the video meeting.

In an embodiment of the present invention, the meeting data includes, but not limited to, a list of meeting members and a meeting schedule. After the meeting server 11 transmits the meeting data to the client device 12 or the meeting terminal 13, the user can operate the user interface of the input unit 124 of the client device 12 according to the meeting data, which enables the processing unit 121 to perform the meeting control operation. The meeting control operation may include, but not limited to, at least one of steps of inviting a meeting member to attend the video meeting, removing a meeting member from the video meeting, turning off or turning on the microphone for a meeting member in the video meeting, turning off or turning on the microphone of the meeting terminal, turning off or turning on the microphone of the client device, turning off or turning on the camera of the meeting terminal, and turning off or turning on the camera of the client device.

It is understood that the client device 12 and the meeting terminal 13 attend the video meeting conducted by the meeting server 11 with the same meeting membership when the client device 12, the meeting terminal 13, and the meeting server 11 create the link of the video meeting and conduct the video meeting. In practical applications, the user can use his/her own account and access his/her own data on the meeting terminal 13 in meeting room A. However, if meeting room A is occupied, the user can also move to meeting room B. Then, the user can use his/her own account and access his/her own data on the meeting terminal 13 in meeting room B. Therefore, the meeting terminal 13 of the present invention can facilitate data sharing.

In Step S05, the meeting server 11 transmits meeting video data to the meeting terminal 13 corresponding to the client device 12 configured in a control mode. In this step, the meeting server 11 transmits the meeting video data to the meeting terminal 13 and the display unit 134 of the meeting terminal 13 displays the meeting video data. The display unit 134 may be the built-in screen of the meeting terminal 13 or a large-size display externally connected to the output of the meeting terminal 13. Therefore, the meeting video data viewed by the users during the video meeting may not be limited by the display unit 124 of the client device 12.

In Step S06, the client device 12 transmits the user audio data to the meeting server 11 during the video meeting. The client device 12 employs the microphone 122 to convert the sounds of the user into the user audio data and then transmits the user audio data to the meeting server 11. In another embodiment of the present invention, the meeting terminal 13 employs the microphone 132 to convert the sounds of the user into the user audio data and then transmits the user audio data to the meeting server 11. According to the foregoing description, it is known that the sounds of the user may be selectively retrieved by the microphone 122 of the client device 12 or the microphone 132 of the meeting terminal 13 during the video meeting.

In Step S07, the meeting server 11 transmits the meeting audio data to the meeting terminal 13. The speaker 136 of the meeting terminal 13 receives and plays the meeting audio data. In another embodiment of the present invention, the meeting server 11 transmits the meeting audio data to the speaker 126 of the client device 12 to play the meeting audio data.

According to the foregoing steps, it is known that the client device 12 and the meeting terminal 13 attend the video meeting conducted by the meeting server 11 with the same meeting membership. The meeting server 11 respectively transmits different data associated with the video meeting to the client device 12 and the meeting terminal 13. As a result, the user can conveniently operate the familiar client device 12 (e.g., smart phone) as a control device to conduct a video meeting and perform a meeting control operation at any time. The meeting video data of the video meeting can be displayed on the display unit 134 (usually having a larger display size) of the meeting terminal 13.

Besides, the client device 12 and the meeting terminal 13 can both have complete functional units (including a microphone, a camera, a display unit, an input unit, and a speaker). When the client device 12 or the meeting terminal 13 lacks a part of the functional units, the client device 12 or the meeting terminal 13 can employ the same functional unit to provide support. Alternatively, when one of the functional units has better performance, it is designated by the user to use. When the user has specific consideration, the functional unit may be designated by the user for use.

For example, when the client device 12 is a newer smart phone whose camera has better performance on the market, the user can obtain the user video data by operating the client device 12 to select the camera 123 of the client device 12 rather than the camera 133 of the meeting terminal 13. Alternatively, when the user arrives at the meeting room and finds that the camera 133 of the meeting terminal 13 has been already broken, the user immediately employs the camera 123 of the client device 12 to obtain the user video data, thereby conducting the video meeting.

In another case, the meeting room may have a large space and the user is far away from the microphone 132 of the meeting terminal 13. Thus, the reception of the sounds is unsatisfactory. As a result, the user can obtain the user audio data by selecting the microphone 122 of the client device 12 rather than the microphone 132 of the meeting terminal 13.

According to the forgoing description, it is understood that the present invention provides a method of conducting a meeting and controlling a meeting terminal with a client device, which prevents users from forgetting to log out of their accounts on other devices, conveniently uses your own account on different terminal devices to share personal data, and allows users to operate familiar devices and user interface for control. Besides, the method of the present invention can also flexibly allow the user to select the functional unit of the client device 12 or the meeting terminal 13 according to the situation.

Although various examples of the disclosed technology have been described above, it should be understood that these examples have been presented by examples rather than limited. Likewise, various drawings may depict example architectures or other configurations of the disclosed technology. The drawings may be depicted to assist in understanding the features and functionality that may be included in the disclosed technology. The disclosed technology is not limited to the illustrated example architectures or configurations, but the desired features can be implemented using a variety of alternative architectures and configurations. In fact, it will be obvious to those skilled in the art to know how to implement alternative functionalities, logical or physical partitions and configurations to implement the required features of the technology disclosed in this article. In addition, with regard to flowcharts, operation descriptions, and methodological technical solutions, the order in which the steps are presented herein should not require that the disclosed technologies be implemented in the same order to perform the listed functionality, unless the context dictates otherwise.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A method of conducting a meeting and controlling a meeting terminal with a client device, the client device, the meeting terminal, and a meeting server connected to each other via a network, and the method operating in an environment of the meeting server, the client device, and the meeting terminal and comprising:
(A) pairing the client device with the meeting terminal;
(B) configuring the client device into a control mode corresponding to the paired client device and the paired meeting terminal;
(C) configuring the meeting terminal into a display mode corresponding to the paired client device and the paired meeting terminal;
(D) operating the client device to enable the meeting terminal to conduct a video meeting corresponding to the client device configured in a control mode; and
(E) by the meeting server, transmitting meeting video data to the meeting terminal corresponding to the client device configured in a control mode.

2. The method of conducting a meeting and controlling a meeting terminal with a client device according to claim 1, wherein in step (D), the meeting server transmits meeting data to the client device and the client device performs a meeting control operation according to the meeting data.

3. The method of conducting a meeting and controlling a meeting terminal with a client device according to claim 2, wherein the meeting data includes a list of meeting members and a meeting schedule.

4. The method of conducting a meeting and controlling a meeting terminal with a client device according to claim 2, wherein the meeting control operation includes at least one of steps:
inviting a meeting member to attend the video meeting;
removing a meeting member from the video meeting;
turning off or turning on a microphone for a meeting member in the video meeting;
turning off or turning on a microphone of the meeting terminal;
turning off or turning on a microphone of the client device;
turning off or turning on a camera of the meeting terminal; and
turning off or turning on a camera of the client device.

5. The method of conducting a meeting and controlling a meeting terminal with a client device according to claim 1, wherein in step (D), the meeting server transmits meeting data to the client device and the client device displays the meeting data.

6. The method of conducting a meeting and controlling a meeting terminal with a client device according to claim 5, wherein a user operates the client device according to the meeting data displayed by the client device, which enables the meeting terminal to conduct the video meeting.

7. The method of conducting a meeting and controlling a meeting terminal with a client device according to claim 1, wherein in step (D), the meeting server transmits meeting data to the meeting terminal and the meeting terminal displays the meeting data.

8. The method of conducting a meeting and controlling a meeting terminal with a client device according to claim 7, wherein a user operates the client device according to the meeting data displayed by the meeting terminal, which enables the meeting terminal to conduct the video meeting.

9. The method of conducting a meeting and controlling a meeting terminal with a client device according to claim 1, wherein in step (D), the client device and the meeting terminal attend the video meeting conducted by the meeting server with a same meeting membership.

10. The method of conducting a meeting and controlling a meeting terminal with a client device according to claim 1, wherein the meeting server respectively transmits different data associated with the video meeting to the client device and the meeting terminal.

11. The method of conducting a meeting and controlling a meeting terminal with a client device according to claim 1, further comprising:
(F) by the client device, transmitting user audio data to the meeting server when the video meeting is conducted; and
(G) by the meeting server, transmitting meeting audio data to the meeting terminal.

12. The method of conducting a meeting and controlling a meeting terminal with a client device according to claim 1, wherein in step (D), the client device transmits user video data to the meeting server when the video meeting is conducted.

13. The method of conducting a meeting and controlling a meeting terminal with a client device according to claim 1, wherein in step (D), the meeting terminal transmits user video data to the meeting server when the video meeting is conducted.
